(19) United States
(12) Patent Application Publication
(10) Pub. No.: US 2017/0363809 A1
(43) Pub. Date: Dec. 21, 2017

(54) OPTICAL FIBER END CAP HOLDER

(71) Applicant: AFL Telecommunications LLC, Duncan, SC (US)

(72) Inventors: Wenxin Zheng, Moore, SC (US); Brad Hendrix, Campobello, SC (US); Usman B. Nasir, Greer, SC (US)

(21) Appl. No.: 15/622,650

(22) Filed: Jun. 14, 2017

Related U.S. Application Data
(60) Provisional application No. 62/351,709, filed on Jun. 17, 2016.

(51) Int. Cl. G02B 6/255; G02B 6/38; B25B 11/00

(52) U.S. Cl. CPC G02B 6/2555; B25B 11/005; G02B 6/3849

(57) ABSTRACT

An end cap holder includes a main body and a pump which generates a vacuum pressure. The main body includes a bore hole extending therethrough along a central axis, and a contact surface which surrounds an end of the bore hole. Activation of the pump may generate a vacuum pressure within the bore hole.

### CROSS-REFERENCE TO RELATED APPLICATIONS

This application is based upon and claims the benefit of priority from U.S. Provisional Patent Application No. 62/351,709, filed Jun. 17, 2016, the disclosure of which is incorporated by reference herein in its entirety.

### FIELD OF THE INVENTION

The present disclosure relates generally to end cap holders for optical fiber end caps, and more particularly to end cap holders which utilize vacuum pressure to hold the end caps in place.

### BACKGROUND OF THE INVENTION

End caps are widely utilized in various optical fiber applications. The end cap typically has a different diameter than the optical fiber to which it is attached. These different diameters allow the power density at the end of the optical fiber to be adjusted. For example, a larger diameter end cap may decrease the power density at the end of the optical fiber.

One method for attaching an end cap to an optical fiber is to splice the end cap to the optical fiber. The end cap may, for example, be clamped in place and aligned with the optical fiber for such splicing. However, in order for the end cap to be clamped and have a portion exposed for splicing, the end cap must be relatively long. It is thus difficult to splice relatively shorter end caps to optical fibers.

Accordingly, improved end cap holders would be desired in the art. In particular, end cap holders which facilitate splicing of relatively shorter end caps to optical fibers would be advantageous.

### BRIEF DESCRIPTION OF THE INVENTION

Aspects and advantages of the invention will be set forth in part in the following description, or may be obvious from the description, or may be learned through practice of the invention.

In accordance with one embodiment of the present disclosure, an end cap holder is provided. The end cap holder includes a main body and a pump which generates a vacuum pressure. The main body includes a bore hole extending therethrough along a central axis, and a contact surface which surrounds an end of the bore hole. Activation of the pump may generate a vacuum pressure within the bore hole.

In exemplary embodiments, a rigid sleeve may be provided to connect a hose of the pump and the main body.

In exemplary embodiments, the contact surface may be disposed within a recess defined in the main body.

In exemplary embodiments, the contact surface is oriented perpendicular to the bore hole and central axis. The contact surface may, for example, be a flat, planer surface.

In exemplary embodiments, the contact surface may be a polished surface.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a side perspective view of an end cap holder in accordance with embodiments of the present disclosure; and

FIG. 2 is a side cross-sectional view of an end cap holder in accordance with embodiments of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The present disclosure generally provides end cap holders which advantageously utilize vacuum pressure, rather than physical clamping mechanisms or other mechanical affixing apparatus, to hold end caps for splicing. The use of such vacuum pressure advantageously allows the end cap to be properly positioned for splicing together with an optical fiber. Further, because only vacuum pressure is utilized to hold the end cap in place with the end cap holder, end caps having relatively smaller lengths can advantageously be utilized.

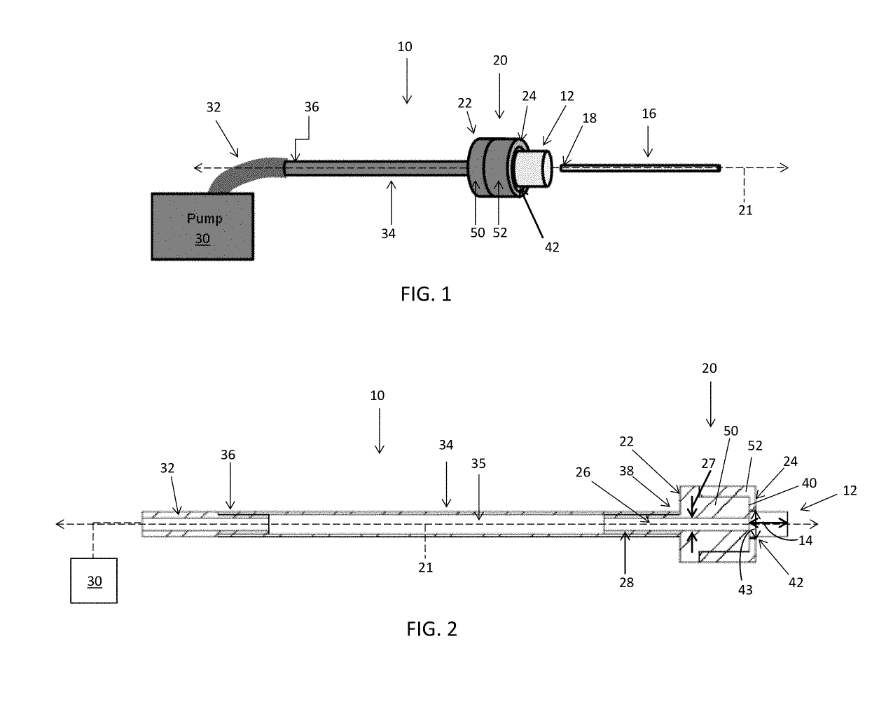

Referring now to FIGS. 1 and 2, an end cap holder 10 for releasably holding an end cap 12 is provided. Any suitable end caps 12 may be utilized. For example, an end cap 12 may be formed from silica, and may be a pure silica end cap, a doped end cap (such as a Graded Index Lens (“GRIN”) end cap, an end cap having an antireflection coating, an end cap having a curved lens, or any other suitable end cap suitable for use with an optical fiber.

The end cap 12 may have any suitable maximum diameter (which may be greater than or less than the maximum diameter of the optical fiber to which the end cap 12 is being attached) and any suitable maximum length 14. End cap holders 10 in accordance with the present disclosure are particularly useful with end caps 12 that have maximum lengths of less than or equal to 5 millimeters, such as less than or equal to 4 millimeters, such as less than or equal to 3 millimeters, such as between 1 millimeter and 3 millimeters.

An end cap 12 may be attached to the end 18 of an optical fiber 16. Any suitable optical fiber 16 may be utilized, whether single mode or multi-mode, and having any suitable maximum diameter. The end cap 12 and the optical fiber 16 may be spliced together, i.e. via fusion splicing, laser splicing, or another suitable splicing technology.

As illustrated, end cap holder 10 may include a main body 20 which may extend along a central axis 21 between a first end 22 and a second end 24. A bore hole 26 may be defined through the main body 20 along the central axis 21. In some embodiments, a male connector tube 28 (which may have a smaller maximum diameter than the main body 20) may extend along the central axis 21 from the first end 22, and the bore hole 26 may additionally be defined through the connector tube 28.

As discussed herein, an end cap 12 may be releasably held in contact with the main body 20 adjacent the second end 24 via a vacuum pressure that is generated through the main body 20, and specifically through the bore hole 26. A pump 30, such as a vacuum pump, may be in fluid communication with the main body 20 to generate a vacuum pressure (i.e. a suction or negative pressure) within the bore hole 26. Notably, the required vacuum pressure for use in holding an end cap 12 in accordance with the present disclosure may advantageously be relatively minimal, thus facilitating both secure holding during splicing and easy removal from the holder 10 after removal. For example, the required vacuum pressure may be less than 10 pounds per square inch (“psi”), such as less than 6 psi, such as less than 5 psi, such as between 3 psi and 5 psi.

A hose 32 may extend from the pump 30 and connect the pump 30 to the main body 20. In some embodiments, for example, the hose 32 may be in contact with the main body 20. For example, a portion of the hose 32 may fit over or within the connector tube 28. In these embodiments, the vacuum pressure generated by the pump 20 is provided through hose 32 to bore hole 26. Alternatively, a rigid sleeve 34 may be provided between the hose 32 and the main body 20. The rigid sleeve 34 may, for example, be formed from a suitable metal. The rigid sleeve 34 may extend along the central axis 21 between a first end 36 and a second end 38. A bore hole 35 may be defined in the rigid sleeve 34, and may extend between the first end 36 and the second end 38 along the central axis 21. The second end 38 of the sleeve 34 may fit over (as shown) or within the connector tube 28, and the first end 28 of the sleeve 34 may fit over (as shown) or within the hose 32. The rigid sleeve 34 may connect the pump 30 and main body 20, such that the vacuum pressure generated by the pump 20 is provided to bore hole 26 through hose 32 and bore hole 35.

Notably, when a rigid sleeve 34 is utilized, the sleeve 24 may be clamped in the splicer to position the end cap holder 10, and thus the end cap 12, for splicing together with an optical fiber 16.

In exemplary embodiments, the main body 20 is generally cylindrical. An end cap 12 may be releasably held in contact with the main body 20 adjacent the second end 24 via the vacuum pressure. For example, the main body 20 may include a contact surface 40 which an end cap 12 may directly contact when the end cap 12 is releasably held in contact with the main body 20. The contact surface 40 may be concentric with the bore hole 26 and central axis 21, and may thus surround an end of the bore hole 26. In some embodiments, the contact surface 40 may be a portion of the second end 24, such as a portion of the second end 24 surrounding the bore hole 26 at the second end 24. Alternatively, as illustrated, the contact surface 40 may be defined between the first end 22 and the second end 24 along the central axis 21. For example, a recess 42 may be defined in the main body 20. In exemplary embodiments, recess 42 is generally cylindrical. Recess 42 may be defined in the second end 24, and may extend from the second end 24 towards the first end 22 along the central axis 21. A maximum diameter 43 of the recess 42 may be greater than a maximum diameter 27 of the bore hole 26, and may further be greater than a maximum diameter of an end cap 12 to be releasably held by the main body 20. The recess 42 may be concentric with the bore hole 26 and central axis 21. The contact surface 40 may be defined within the recess 42, and may be the surface of the main body 20 that is a base defining the recess 42. Accordingly, in these embodiments, when an end cap 12 is removably held by end cap holder 10, a portion of the end cap 12 may be disposed within the recess 42.

The main body 20 may be formed as a single, unitary component, or may be formed from multiple components. Additionally, the connector tube 28 may be integral with the main body 20 (or a component thereof) to form a single unitary component, or may be a separate component connected thereto. For example, in exemplary embodiments, the main body 20 may include a plug 50 and a socket 52. The plug 50 may include the first end 22, and the connector tube 28 may be integral with or connected to the plug 50. Additionally, and notably, a distal end (from the first end 22 of the plug 50 may be or include the contact surface 40. The socket 52 may include the second end 24. The plug 50 may be disposed at least partially within the socket 52, such as via a press-fit or other suitable connection, to form the main body 20.

In exemplary embodiments, the main body 20 is formed from a metal. In embodiments, wherein multiple components (such as a plug and socket) are utilized, these components may be formed from the same or different materials. Additionally, the connector tube 28 may in exemplary embodiments be formed from a metal, which may be the same as or different from the material(s) of the main body 20.

The contact surface 40 may advantageously be oriented perpendicular to the central axis 21. Further, the contact surface 40 may be a flat, planer surface. Still further, the contact surface 40 may advantageously be a polished surface. For example, the contact surface 40 in exemplary embodiments may be polished with at least a 320 grit material and/or may have a #8 Mirror Finish level polish. Such configuration of the contact surface 40 advantageously allows the end cap 12 to accurately be positioned concentrically with the central axis 21 and with the optical fiber 16 to which the end cap 12 is to be spliced. This facilitates accurate attachment of the end cap 12 to the optical fiber 16.

To utilize end cap holders 10 in accordance with the present disclosure, the pump 30 may be activated to generate a vacuum pressure within the bore hole 26. An end cap 12 may then be placed against the contact surface 40 and an end of the bore hole 26 surrounded by the contact surface 40. The vacuum pressure may force the end cap 12 against the contact surface 40, and thus removably hold the end cap 12 on the end cap holder 10.

The vacuum pressure generated by pump 30 may be maintained during splicing. Accordingly, the end cap holder 10 may be place and secured in a suitable splicer. An end cap 12 may be placed on the contact surface 40 and removably held by the end cap holder 10 before or after securing of the end cap holder 10 in the splicer. An optical fiber 16 may be secured in the splicer and placed into contact with the end cap 12, and the end cap 12 and optical fiber 16 may be spliced together. The end cap 12 may then be easily removed from the end cap holder 10, such as by pulling the end cap 12 from the contact surface 40. Accordingly, easy, efficient and accurate end cap 12 attachment to optical fibers 16 is facilitated by end cap holders 10 in accordance with the present disclosure.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An end cap holder, the end cap holder comprising:
a main body, the main body defining a bore hole which extends through the main body along a central axis, the main body further comprising a contact surface which surrounds an end of the bore hole; and
a pump, the pump in fluid communication with the main body and operable to generate a vacuum pressure within the bore hole,
wherein an end cap is releasably positionable in direct contact with the contact surface by the vacuum pressure.

2. The end cap holder of claim 1, further comprising a rigid sleeve connecting a hose of the pump and the main body.

3. The end cap holder of claim 2, wherein the main body comprises a connector tube extending from a first end of the main body along the central axis, the connector tube further defining the bore hole, and wherein the rigid sleeve is connected to the connector tube.

4. The end cap holder of claim 1, wherein the contact surface is disposed within a recess defined in the main body.

5. The end cap holder of claim 4, wherein a maximum diameter of the recess is greater than a maximum diameter of the bore hole.

6. The end cap holder of claim 1, wherein the contact surface is oriented perpendicular to the bore hole and the central axis.

7. The end cap holder of claim 1, wherein the contact surface is planer.

8. The end cap holder of claim 1, wherein the contact surface is a polished surface.

9. The end cap holder of claim 1, wherein the main body comprises a plug and a socket, the plug including the contact surface.

10. The end cap holder of claim 1, wherein the main body is formed from a metal.

11. The end cap holder of claim 1, wherein the vacuum pressure is less than 10 pounds per square inch.

12. An end cap holder, the end cap holder comprising:
a main body, the main body defining a bore hole which extends through the main body along a central axis, the main body further comprising a contact surface which surrounds an end of the bore hole, wherein the contact surface is disposed within a recess defined in the main body;
a pump, the pump in fluid communication with the main body and operable to generate a vacuum pressure within the bore hole; and
a rigid sleeve connecting a hose of the pump and the main body.

13. The end cap holder of claim 12, wherein the main body comprises a connector tube extending from a first end of the main body along the central axis, the connector tube further defining the bore hole, and wherein the rigid sleeve is connected to the connector tube.

14. The end cap holder of claim 12, wherein a maximum diameter of the recess is greater than a maximum diameter of the bore hole.

15. The end cap holder of claim 12, wherein the contact surface is oriented perpendicular to the bore hole and the central axis.

16. The end cap holder of claim 12, wherein the contact surface is planer.

17. The end cap holder of claim 12, wherein the contact surface is a polished surface.

18. The end cap holder of claim 12, wherein the main body comprises a plug and a socket, the plug including the contact surface.

19. The end cap holder of claim 12, wherein the main body is formed from a metal.

20. The end cap holder of claim 12, wherein the vacuum pressure is less than 10 pounds per square inch.
